(19) United States
(12) Patent Application Publication
(10) Pub. No.: US 2025/0204492 A1
(43) Pub. Date: Jun. 26, 2025

(54) ANIMAL APPENDAGE COVERING DEVICE

(71) Applicant: Jameson Marquis, Derry, NJ (US)

(72) Inventor: Jameson Marquis, Derry, NJ (US)

(21) Appl. No.: 18/427,183

(22) Filed: Jan. 30, 2024

Related U.S. Application Data
(60) Provisional application No. 63/612,727, filed on Dec. 20, 2023.

(51) Int. Cl. A01K 13/00

(52) U.S. Cl. CPC A01K 13/007

(57) ABSTRACT

An animal appendage covering device is provided. The device is comprised of waterproof silicone body that is generally tubular. The body can be placed around an animal's tail, legs, and/or joints in a plurality of scenarios to protect said body part.

### CROSS-REFERENCE TO RELATED APPLICATION

The present application claims priority to, and the benefit of, U.S. Provisional Application No. 63/612,727, which was filed on Dec. 20, 2023, and is incorporated herein by reference in its entirety.

### FIELD OF THE INVENTION

The present invention relates generally to the field of animal-worn devices. More specifically, the present invention relates to an animal appendage covering device that can be used to cover a stitched wound, protect an animal's legs or tail from damage, and also provide support to an animal's joints. Accordingly, the present disclosure makes specific reference thereto. Nonetheless, it is to be appreciated that aspects of the present invention are also equally applicable to other like applications, devices, and methods of manufacture.

### BACKGROUND

Animals may suffer from various injuries that require stitches. As a result, animal owners must ensure the animal does not rip out the stitches by biting/licking them, which could lead to further complications or infections. Often, this means outfitting the animal with a cone. While effective in preventing the animal from licking or biting at their stitches, these cones can be uncomfortable and disorienting for the pet.

Additionally, working or hunting dogs, are more prone to specific types of injuries. For instance, said dogs may sustain wounds to their legs or tails from running through dense brush or smacking into tree limbs during their hunting or work. Said dogs may also get caught in burrs or tangled in thickets, leading to skin abrasions or deeper cuts that require medical attention.

Another common issue seen in dogs is a condition colloquially known as “happy tail.” This condition occurs when dogs inadvertently hurt themselves or others by wagging their tails too hard against hard surfaces, leading to injuries that might need stitches.

Moreover, age-related ailments are a significant concern for elderly pets. Joint pain and stiffness in limbs are common in older animals, which can affect their mobility and overall quality of life.

Therefore, there exists a long-felt need in the art for a multi-purpose device for animal protection and health. There also exists a long-felt need in the art for an animal appendage covering device. More specifically, there exists a long-felt need in the art for an animal appendage covering device that can be applied over a stitched wound to prevent an animal from ripping out stitches from the wound. There also exists a long-felt need in the art for an animal appendage covering device that can be applied over the legs and/or tail of a dog to protect the dog while hunting or working. Further, there exists a long-felt need in the art for an animal appendage covering device that can be applied over the tail of a dog to prevent damage from “happy tail”. Finally, there exists a long-felt need in the art for an animal appendage covering device that can be applied over the joints of an animal to provide comfort and support.

The subject matter disclosed and claimed herein, in one embodiment thereof, comprises an animal appendage covering device. The device is comprised of a waterproof silicone body that is generally tubular. The body can be placed around an animal's tail, legs, and/or joints in a plurality of scenarios to protect said body part.

In this manner, the animal appendage covering device of the present invention accomplishes all the foregoing objectives and provides a multi-purpose device for animal protection and health. More specifically, the device can be applied over a stitched wound to prevent an animal from ripping out stitches from the wound. The device can also be applied over the legs and/or tail of a dog to protect the dog while hunting or working. Further, the device can be applied over the tail of a dog to prevent damage from “happy tail”. Finally, the device can be applied over the joints of an animal to provide comfort and support.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an animal appendage covering device comprised of a body preferably made from a high-elasticity silicone material that is waterproof. The body is comprised of a first end with a first opening and a second end comprised of a second opening that allows the body to be placed over the tail, leg, foot, joint, etc., of an animal. The body material may also be deformable such that it can be molded into shape to fit around a desired appendage/body area of an animal as described above.

The present invention is also comprised of a first method of using the device to cover an animal wound that may or may not be stitched. First, a device is provided comprised of a silicone body comprised of a first end comprised of a first opening and a second end comprised of a second opening. Then, the body can be placed around an animal's tail, leg, or foot in the area of the tail, leg, or foot that contains the wound (wherein the wound may or may not have stitches).

The present invention is also comprised of a second method of using the device for using the device to cover a portion of an animal's body while hunting/working. First, a device is provided comprised of a silicone body comprised of a first end comprised of a first opening and a second end comprised of a second opening. Then, the body can be placed around an animal's tail, leg, or foot in any area of the tail, leg, or foot prior to hunting or working.

The present invention is also comprised of a third method of using the device for using the device to cover a portion of an animal's tail to prevent “happy tail” injuries. First, a device is provided comprised of a silicone body comprised of a first end comprised of a first opening and a second end comprised of a second opening. Then, the body can be placed around an animal's tail to prevent impact damage to the tail.

The present invention is also comprised of a fourth method of using the device for using the device to cover an animal's joint to provide support and comfort. First, a device is provided comprised of a silicone body comprised of a first end comprised of a first opening and a second end comprised of a second opening. Then, the body can be placed around an animal's joint to provide support and comfort to the joint.

Accordingly, the animal appendage covering device of the present invention is particularly advantageous as it provides a multi-purpose device for animal protection and health. More specifically, the device can be applied over a stitched wound to prevent an animal from ripping out stitches from the wound. The device can also be applied over the legs and/or tail of a dog to protect the dog while hunting or working. Further, the device can be applied over the tail of a dog to prevent damage from “happy tail”. Finally, the device can be applied over the joints of an animal to provide comfort and support. In this manner, the animal appendage covering device overcomes provides a solution to various animal health problems and situations known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an animal appendage covering device of the present invention in accordance with the disclosed architecture;

FIG. 2 illustrates a perspective view of one potential embodiment of an animal appendage covering device of the present invention while covering a wound on an animal's leg/foot and covering an animal's joint in accordance with the disclosed architecture;

FIG. 3 illustrates a perspective view of one potential embodiment of an animal appendage covering device of the present invention while covering an animal's tail in accordance with the disclosed architecture;

FIG. 4 illustrates a flowchart of a method of using one potential embodiment of an animal appendage covering device of the present invention in accordance with the disclosed architecture;

FIG. 5 illustrates a flowchart of a method of using one potential embodiment of an animal appendage covering device of the present invention in accordance with the disclosed architecture;

FIG. 6 illustrates a flowchart of a method of using one potential embodiment of an animal appendage covering device of the present invention in accordance with the disclosed architecture; and

FIG. 7 illustrates a flowchart of a method of using one potential embodiment of an animal appendage covering device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a multi-purpose device for animal protection and health. There also exists a long-felt need in the art for an animal appendage covering device. More specifically, there exists a long-felt need in the art for an animal appendage covering device that can be applied over a stitched wound to prevent an animal from ripping out stitches from the wound. There also exists a long-felt need in the art for an animal appendage covering device that can be applied over the legs and/or tail of a dog to protect the dog while hunting or working. Further, there exists a long-felt need in the art for an animal appendage covering device that can be applied over the tail of a dog to prevent damage from “happy tail”. Finally, there exists a long-felt need in the art for an animal appendage covering device that can be applied over the joints of an animal to provide comfort and support.

The present invention, in one exemplary embodiment, is comprised of an animal appendage covering device. The device is comprised of a waterproof silicone body that is generally tubular. The body can be placed around an animal's tail, legs, and/or joints in a plurality of scenarios to protect said body part.

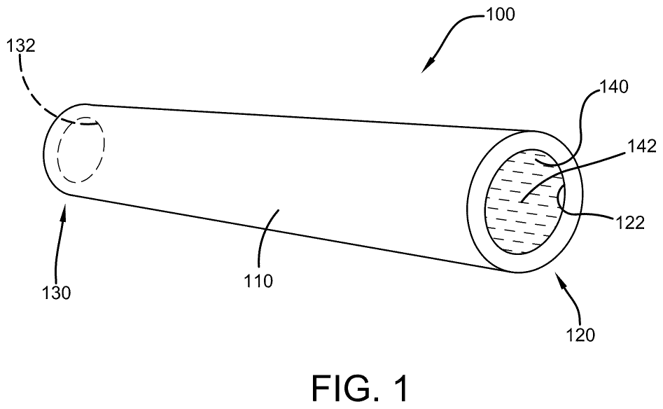

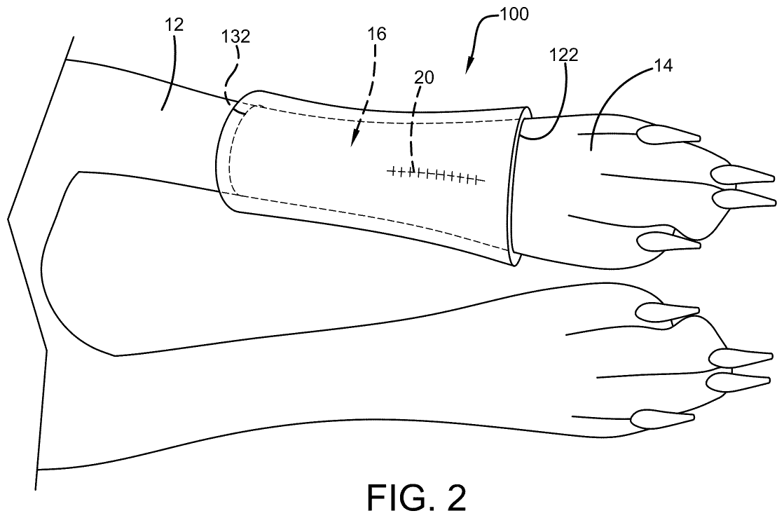

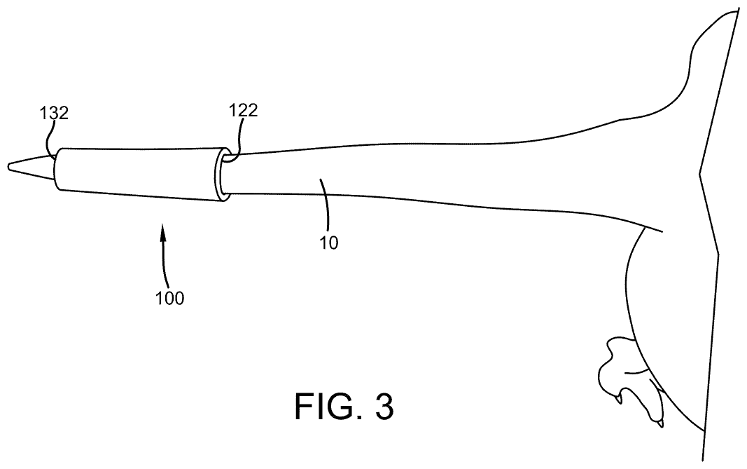

Referring initially to the drawings, FIG. 1 illustrates a perspective view of one potential embodiment of an animal appendage covering device 100 of the present invention in accordance with the disclosed architecture. The device 100 is comprised of a body 110 that is generally tubular in shape. The body 110 is preferably made from a high-elasticity silicone material. Said material is preferably waterproof. Further, in one embodiment the body 110 (and/or the interior surface 140 of the body 110) is comprised of a sterile and/or anti-bacterial coating 142. In one embodiment, the coating 142 may be a medicated and/or pain relief compound. The body 110 is comprised of a first end 120 with a first opening 122 and a second end 130 comprised of a second opening 132. The openings 122,132 allow the body 110 to be placed over the tail 10 (as seen in FIG. 3), leg 12 (as seen in FIG. 2), foot 14, joint 16, etc., of an animal. The body 110 material may also be deformable, such that it can be molded into shape to fit around a desired appendage/body area of an animal as described above.

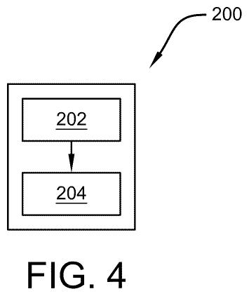

The present invention is also comprised of a first method of using 200 the device 100 to cover an animal wound 20 that may or may not be stitched, as seen in FIG. 4. First, a device 100 is provided comprised of a silicone body 110 comprised of a first end 120 comprised of a first opening 122 and a second end 130 comprised of a second opening 132 [Step 202]. Then, the body 110 can be placed around an animal's tail 10, leg 12, or foot 14 in the area of the tail 10, leg 12, or foot 14 that contains the wound 20 (wherein the wound may or may not have stitches) [Step 204].

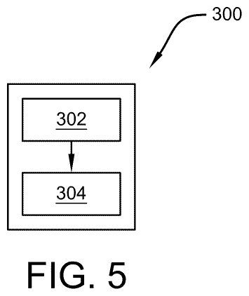

The present invention is also comprised of a second method of using 300 the device 100 to cover a portion of an animal's body while hunting/working, as seen in FIG. 5. First, a device 100 is provided comprised of a silicone body 110 comprised of a first end 120 comprised of a first opening 122 and a second end 130 comprised of a second opening 132 [Step 302]. Then, the body 110 can be placed around an animal's tail 10, leg 12, or foot 14 in the area of the tail 10, leg 12, or foot prior to hunting or working [Step 304].

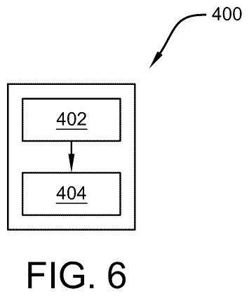

The present invention is also comprised of a third method of using 400 the device 100 to cover a portion of an animal's tail 10 to prevent “happy tail” injuries, as seen in FIG. 6. First, a device 100 is provided comprised of a silicone body 110 comprised of a first end 120 comprised of a first opening 122 and a second end 130 comprised of a second opening 132 [Step 402]. Then, the body 110 can be placed around an animal's tail 10 to prevent impact damage to the tail 10 [Step 404].

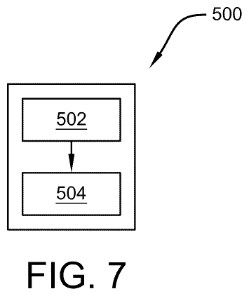

The present invention is also comprised of a fourth method of using 500 the device 100 for using the device 100 to cover an animal's joint 16 to provide support and comfort, as seen in FIG. 7. First, a device 100 is provided comprised of a silicone body 110 comprised of a first end 120 comprised of a first opening 122 and a second end 130 comprised of a second opening 132 [Step 502]. Then, the body 110 can be placed around an animal's joint 16 to provide support and comfort to the joint 16 [Step 504].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “animal appendage covering device” and “device” are interchangeable and refer to the animal appendage covering device 100 of the present invention.

Notwithstanding the foregoing, the animal appendage covering device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the animal appendage covering device 100 as shown in the FIGS. are for illustrative purposes only, and that many other sizes and shapes of the animal appendage covering device 100 are well within the scope of the present disclosure. Although the dimensions of the animal appendage covering device 100 are important design parameters for user convenience, the animal appendage covering device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An animal appendage covering device comprising:
a body comprised of a first end having a first opening and a second end having a second opening.

2. The animal appendage covering device of claim 1, wherein the body is comprised of an elastic silicone material.

3. The animal appendage covering device of claim 2, wherein elastic silicone material is waterproof.

4. The animal appendage covering device of claim 2, wherein elastic silicone material is deformable.

5. The animal appendage covering device of claim 1, wherein the body is comprised of a sterile coating or an anti-bacterial material coating.

6. The animal appendage covering device of claim 1, wherein the body is comprised of a medicated coating or a pain-relieving coating.

7. The animal appendage covering device of claim 1, wherein an interior surface of the body is comprised of a sterile or an anti-bacterial material.

8. A method of using an animal appendage covering device to protect a body area of an animal, the method comprising the following steps:
providing an animal appendage covering device comprised of a body comprised of a first end comprised of a first opening and a second end comprised of a second opening; and
placing the body around a body part of an animal.

9. The method of using an animal appendage covering device of claim 8, wherein the body part is comprised of a tail, a leg, or a foot.

10. The method of using an animal appendage covering device of claim 9, wherein the body part is comprised of a wound.

11. The method of using an animal appendage covering device of claim 8 further comprised of placing the body around a body part of an animal prior to the animal hunting or working.

12. The method of using an animal appendage covering device of claim 8, wherein the body is comprised of an elastic silicone material.

13. The method of using an animal appendage covering device of claim 8, wherein the elastic silicone material is waterproof.

14. The method of using an animal appendage covering device of claim 8, wherein the body is comprised of a sterile coating or an anti-bacterial material coating.

15. The method of using an animal appendage covering device of claim 8, wherein the body is comprised of a medicated coating or a pain-relieving coating.

16. The method of using an animal appendage covering device of claim 8, wherein an interior surface of the body is comprised of a sterile or an anti-bacterial material.

17. A method of using an animal appendage covering device to provide support and comfort to a joint of an animal, the method comprising the following steps:
providing an animal appendage covering device comprised of a body comprised of a first end comprised of a first opening and a second end comprised of a second opening; and
placing the body around a joint of an animal.

18. The method of using an animal appendage covering device of claim 17, wherein the body is comprised of an elastic silicone material.

19. The method of using an animal appendage covering device of claim 17, wherein the body is comprised of a sterile coating or an anti-bacterial material coating.

20. The method of using an animal appendage covering device of claim 17, wherein the body is comprised of a medicated coating or a pain-relieving coating.
